(19) United States
(12) Patent Application Publication
(10) Pub. No.: US 2018/0183645 A1
(43) Pub. Date: Jun. 28, 2018

(54) Device and Method for Reducing Complexity of Preamble Detection

(71) Applicant: HTC Corporation, Taoyuan City (TW)

(72) Inventor: Ling-San Meng, Taoyuan City (TW)

(21) Appl. No.: 15/853,998

(22) Filed: Dec. 26, 2017

Related U.S. Application Data
(60) Provisional application No. 62/439,128, filed on Dec. 26, 2016.

(51) Int. Cl. H04L 27/26; H04B 1/708

(52) U.S. Cl. CPC H04L 27/2643; H04L 27/2662; H04B 1/708; H04L 27/2676

(57) ABSTRACT

A communication device for reducing complexity of preamble detection comprises a storage device for storing instructions and a processing circuit coupled to the storage device. The processing circuit is configured to execute the instructions stored in the storage device. The instructions comprise being configured with a plurality of preambles; transmitting a first preamble of the plurality of preambles; and transmitting a second preamble of the plurality of preambles, wherein the first preamble is associated with the second preamble according to an association.

### CROSS REFERENCE TO RELATED APPLICATIONS

This application claims the benefit of U.S. Provisional Applications No. 62/439,128 filed on Dec. 26, 2016, which is incorporated herein by reference.

### BACKGROUND OF THE INVENTION

### 1. Field of the Invention

The present invention relates to a device and a method used in a wireless communication system, and more particularly, to a device and a method of reducing complexity of preamble detection in a wireless communication system.

### 2. Description of the Prior Art

A long-term evolution (LTE) system provides high data rate, low latency, packet optimization, and improved system capacity and improved coverage. The LTE system is evolved continuously to increase peak data rate and throughput by using advanced techniques, such as carrier aggregation (CA), dual connectivity, licensed-assisted access, etc. In the LTE system, a radio access network known as an evolved universal terrestrial radio access network (E-UTRAN) includes at least one evolved Node-B (eNB) for communicating with at least one user equipment (UE), and for communicating with a core network. The core network may include a mobility management and a Quality of Service (QoS) control of the at least one UE.

When a UE establishes an initial connection with a base station (BS), the UE access the BS in a time-frequency resource by transmitting a preamble. Since the BS does not know which preamble is transmitted by the UE, the BS has to detect all allowed preambles to know which preamble is transmitted. However, as the number of the allowed preambles increases (e.g., the number of the preambles to detect is expected to increase in fifth-generation (5G) new radio (NR) systems compared with the case in the LTE system), the detection of all allowed preambles becomes inefficient. Thus, reducing the complexity of preamble detection is an important problem to be solved.

### SUMMARY OF THE INVENTION

The present invention therefore provides a communication device for reducing complexity of preamble detection to solve the abovementioned problem.

A communication device for reducing complexity of preamble detection comprises a storage device for storing instructions and a processing circuit coupled to the storage device. The processing circuit is configured to execute the instructions stored in the storage device. The instructions comprise being configured with a plurality of preambles; transmitting a first preamble of the plurality of preambles; and transmitting a second preamble of the plurality of preambles, wherein the first preamble is associated with the second preamble according to an association.

A BS for reducing complexity of preamble detection comprises a storage device for storing instructions and a processing circuit coupled to the storage device. The processing circuit is configured to execute the instructions stored in the storage device. The instructions comprise configuring a plurality of preambles; detecting a first preamble of the plurality of preambles; detect a second preamble of the plurality of preambles, if the first preamble is successfully detected, wherein the second preamble is associated with the first preamble according to an association; and not detecting the second preamble, if the first preamble is not successfully detected.

A communication device for reducing complexity of preamble detection comprises a storage device for storing instructions and a processing circuit coupled to the storage device. The processing circuit is configured to execute the instructions stored in the storage device. The instructions comprise transmitting a first preamble a base station (BS) with a first length from a plurality of preambles configured by the BS, wherein the plurality of preambles comprises at least a second preamble with a second length, and the first preamble and the second preamble comprise a common segment with a third length, and the third length is smaller than the first length and smaller than the second length.

A BS for reducing complexity of preamble detection comprises a storage device for storing instructions and a processing circuit coupled to the storage device. The processing circuit is configured to execute the instructions stored in the storage device. The instructions comprise configuring a first preamble with a first length and a second preamble with a second length, wherein the first preamble and the second preamble comprise a common segment with a third length, and the third length is smaller than the first length and smaller than the second length; detecting the common segment of the first preamble or the second preamble; and detecting a first remaining segment of the first preamble, if the common segment is successfully detected, wherein the first remaining segment is with a fourth length, and the fourth length is larger than 0 and not larger than (the first length—the third length).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a schematic diagram of an association a plurality of preambles according to an example of the present invention.

FIG. 6 is a flowchart of a process according to an example of the present invention.

FIG. 7 is a flowchart of a process according to an example of the present invention.

FIG. 8 is a schematic diagram of an association a plurality of preambles according to an example of the present invention.

FIG. 9 is a flowchart of a process according to an example of the present invention.

FIG. 10 is a flowchart of a process according to an example of the present invention.

FIG. 11 is a schematic diagram of an association a plurality of preambles according to an example of the present invention.

FIG. 12 is a schematic diagram of a time-frequency resource allocation according to an example of the present invention.

FIG. 13 is a schematic diagram of a time-frequency resource allocation according to an example of the present invention.

FIG. 14 is a schematic diagram of an association a plurality of preambles according to an example of the present invention.

### DETAILED DESCRIPTION

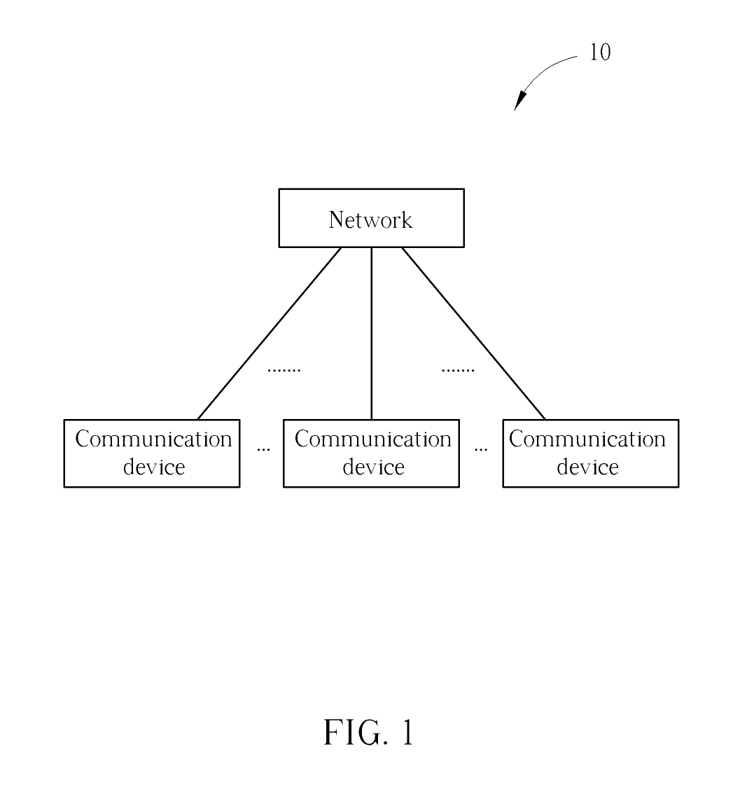

FIG. 1 is a schematic diagram of a wireless communication system 10 according to an example of the present invention. The wireless communication system 10 is briefly composed of a network and a plurality of communication devices. The network and a communication device may communicate with each other via one or more carriers of licensed band(s) and/or unlicensed band(s).

In FIG. 1, the network and the communication devices are simply utilized for illustrating the structure of the wireless communication system 10. The network may be a narrowband (NB) internet of things (IoT) network or an evolved universal terrestrial radio access network (E-UTRAN) including at least one evolved Node-B (eNB) and/or at least one relay station in a long-term evolution (LTE) system, a LTE-Advanced (LTE-A) system or an evolution of the LTE-A system. The eNB or the relay station may be termed as a base station (BS). The network may be a fifth generation (5G) network including at least one 5G BS which employs orthogonal frequency-division multiplexing (OFDM) and/or non-OFDM (e.g., filtered OFDM (F-OFDM), Generalized Frequency Division Multiplexing (GFDM), Universal Filtered Multi-Carrier (UFMC) or Filter Back Multi-Carrier (FBMC)), and a transmission time interval (TTI) shorter than 1 ms (e.g. 100 or 200 microseconds). In general, a BS may also be used to refer any of the eNB and the 5G BS.

A communication device may be a user equipment (UE), a machine type communication (MTC) device, a mobile phone, a laptop, a tablet computer, an electronic book, a portable computer system, a vehicle, or an aircraft. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

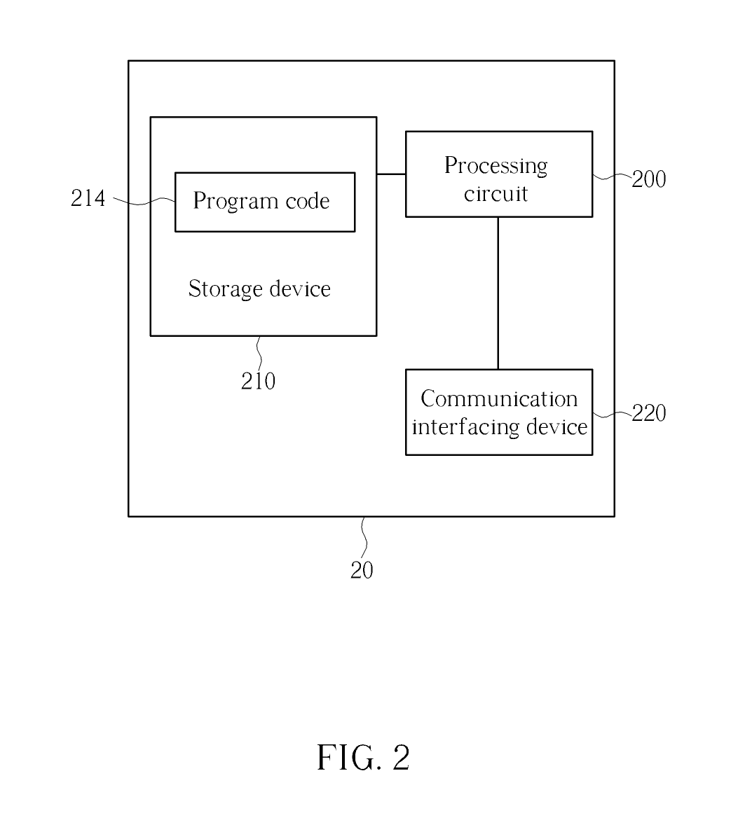

FIG. 2 is a schematic diagram of a communication device 20 according to an example of the present invention. The communication device 20 may be a communication device or the network shown in FIG. 1, but is not limited herein. The communication device 20 may include a processing circuit 200 such as a microprocessor or Application Specific Integrated Circuit (ASIC), a storage device 210 and a communication interfacing device 220. The storage device 210 may be any data storage device that may store a program code 214, accessed and executed by the processing circuit 200. Examples of the storage device 210 include but are not limited to a subscriber identity module (SIM), read-only memory (ROM), flash memory, random-access memory (RAM), hard disk, optical data storage device, non-volatile storage device, non-transitory computer-readable medium (e.g., tangible media), etc. The communication interfacing device 220 is preferably a transceiver and is used to transmit and receive signals (e.g., data, messages and/or packets) according to processing results of the processing circuit 200.

A BS may configure a plurality of preambles for grant-free UL transmissions with at least one UE. A format of the plurality of preambles including a preamble sequence, a modulation format or a length of the plurality of preambles may be pre-determined and written in a specification. Each preamble may be uniquely identified by a set of numeric indices. The BS can configure the plurality of preambles by indicating the associated numeric indices in a configuration message. The preamble sequence can be based on, but not limited to, a Zadoff-Chu sequence or a low density power boosted (LDPB) sequence. In one example, suppose that the Zadoff-Chu sequence is used as the preamble sequence. Each preamble can be uniquely identified by a root index and a value of a cyclic shift. A single unique numeric number index can also be computed according to the root index and the value of the cyclic shift to identify the preamble. Assuming 100 preambles are available, the BS can select and configure a plurality of preambles from the 100 preambles for the grant-free UL transmissions by indicating a plurality of numeric indices corresponding to the plurality of preambles in the configuration message.

The BS configures a method for the at least one UE to transmit the plurality of preambles for the grant-free UL transmissions. The method comprises that the BS determines a level for each preamble of the plurality of preambles. A level 0 preamble (i.e., the preamble of the lowest level) is associated with at least one transmission attribute. A level 1 preamble (i.e., the preamble whose level is higher than the level 0 preamble) is associated to at least one level 0 preamble. A UE transmitting the at least one level 0 preamble must transmit the associated level 1 preamble. The level 0 preambles and the level 1 preambles may or may not be based on the same family of sequences.

In the following embodiments, a UE is used to represent a communication device in FIG. 1, to simplify the illustration of the embodiments.

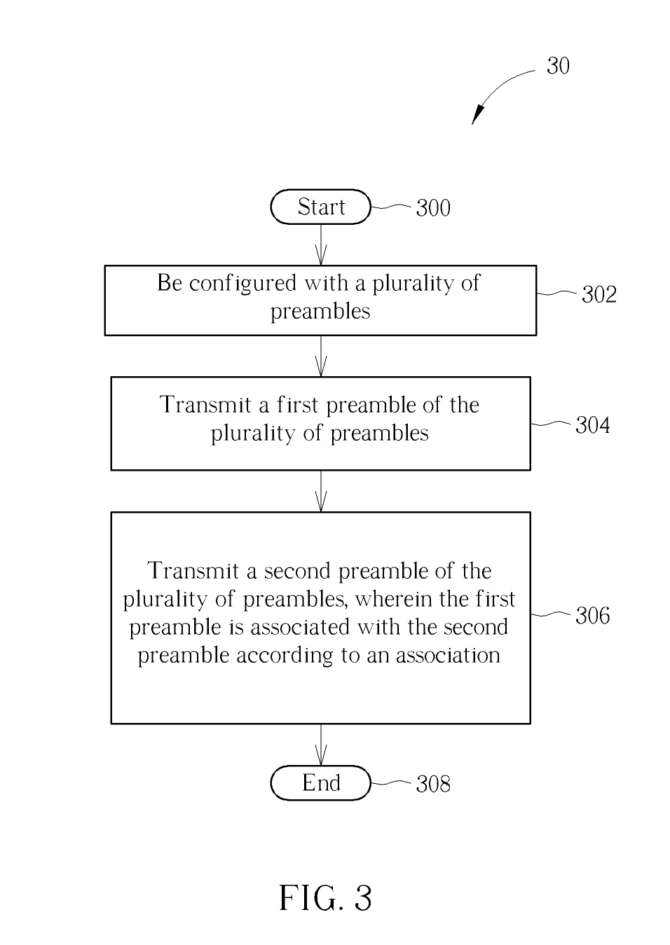

FIG. 3 is a flowchart of a process 30 according to an example of the present invention. The process 30 can be utilized in a UE, for reducing complexity of preamble detection. The process 30 includes the following steps:

Step 300: Start.

Step 302: Be configured with a plurality of preambles.

Step 304: Transmit a first preamble of the plurality of preambles.

Step 306: Transmit a second preamble of the plurality of preambles, wherein the first preamble is associated with the second preamble according to an association.

Step 308: End.

According to the Process 30, the UE is configured with a plurality of preambles. Then, the UE transmits a first preamble (e.g., the preamble of a low level) of the plurality of preambles. After transmitting the first preamble of the plurality of preamble, the UE transmits a second preamble (e.g., the preamble of a high level) of the plurality of preambles, wherein the first preamble is associated with the second preamble according to an association. That is, the UE transmits both the preamble of the low level and the preamble of the high level associated to the preamble of the low level.

Realization of the process 30 is not limited to the above description. The following examples may be applied to the process 30.

In one example, the first preamble is associated with a plurality of transmission attributes. In one example, the UE performs a grant-free UL transmission with the plurality of transmission attributes with a network. In one example, the plurality of transmission attributes include at least one of a UE identity, a NDI, a MCS, a RV index and a MA signature. In one example, a transmission attribute can be the UE identity of a UE which performed the grant-free UL transmission. In one example, a transmission attribute can be the NDI, which signifies that the grant-free UL transmission is a new transmission.

In one example, the association is determined by a BS.

In one example, the first preamble and the second preamble are transmitted in a same time-frequency resource. In one example, the first preamble and the second preamble are transmitted in different time-frequency resources.

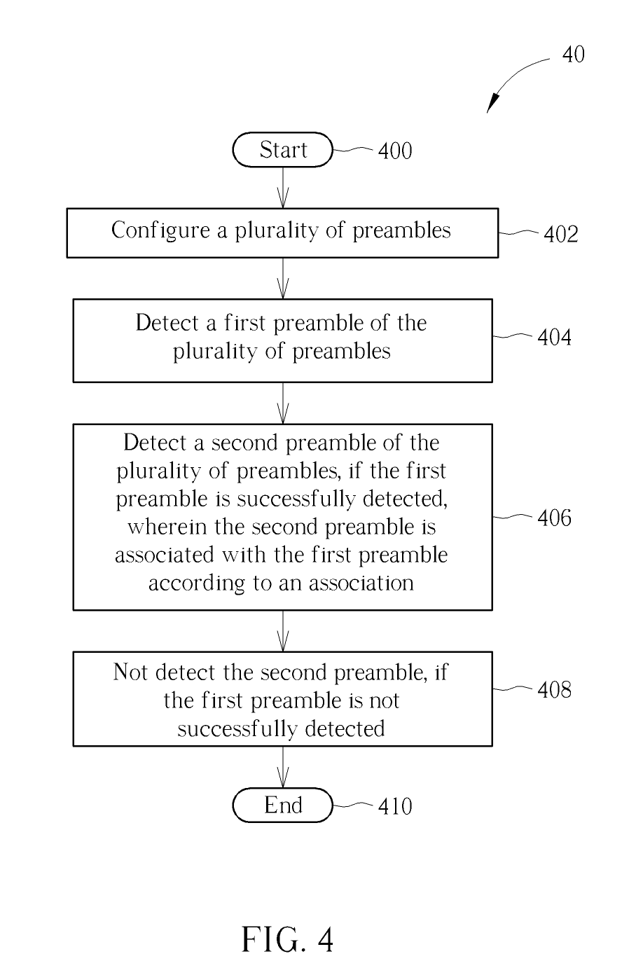

FIG. 4 is a flowchart of a process 40 according to an example of the present invention. The process 40 can be utilized in a BS, for reducing preamble detection complexity. The process 40 includes the following steps:

Step 400: Start.

Step 402: Configure a plurality of preambles.

Step 404: Detect a first preamble of the plurality of preambles.

Step 406: Detect a second preamble of the plurality of preambles, if the first preamble is successfully detected, wherein the second preamble is associated with the first preamble according to an association.

Step 408: Not detect the second preamble, if the first preamble is not successfully detected.

Step 410: End.

According to the process 40, the BS configures a plurality of preambles. Then, the BS detects a first preamble (e.g., the preamble of a high level) of the plurality of preambles. If the first preamble is successfully detected, the BS Detect a second preamble (the preamble of a low level) of the plurality of preambles, wherein the first preamble is associated with the second preamble according to an association. If the first preamble is not successfully detected, the BS does not detect the second preamble. That is, the BS detects the second preamble associated to the first preamble according to the successful detection of the first preamble. The BS does not detect the second preamble associated to the first preamble, before the first preamble is successfully detected. Thus, the complexity of the preamble detection can be reduced.

Realization of the process 40 is not limited to the above description. The following examples may be applied to the process 40.

In one example, the association is determined by the BS.

In one example, when the second preamble is successfully detected, the BS receives and decodes a grant-free UL transmission of at least one grant-free UL transmission with a plurality of transmission attributes, wherein the second preamble is associated with the plurality of transmission attributes.

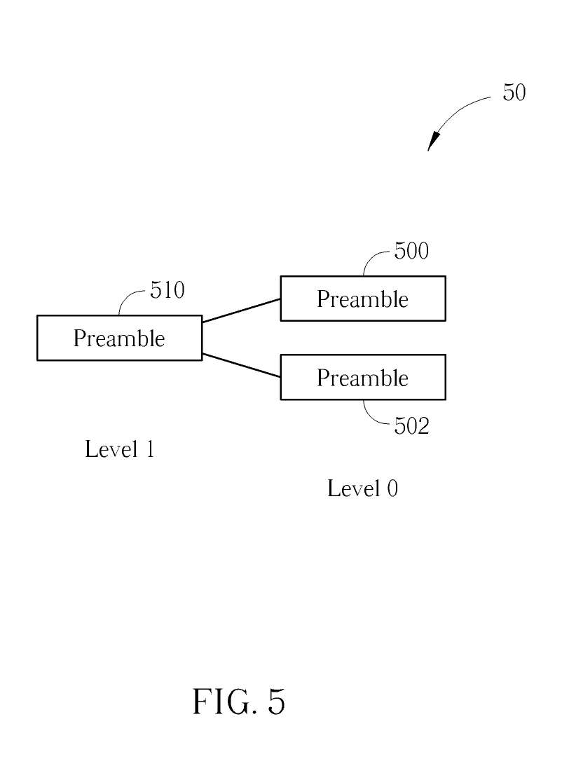

FIG. 5 is a schematic diagram of an association a plurality of preambles 50 according to an example of the present invention. The BS configures a preamble 510 as a high level (e.g., level 1) and preambles 500 and 502 as a low level (e.g., level 0). The BS also configures the preambles 500 and 502 to be associated with the preamble 510 (i.e., a UE must transmit the preamble 510 if the UE transmits the preamble 500 or 502). The BS further configures the preamble 500 to signify the initial UL transmission, and configures the preamble 502 to signify the retransmission. The BS attempts to detect the preamble 510 at every TTI. The BS proceeds to detect the preamble 500 and 502 only according to the successful detection of the preamble 510. If the BS successfully detects the preamble 502, the BS understands that at least one UE performed a retransmission. A UE transmits the preamble 500 when performing the grant-free UL transmission, if the grant-free transmission is an initial transmission. The UE transmits the preamble 502 when performing the grant-free UL transmission, if the grant-free transmission is a retransmission. The UE must also transmit the preamble 510 in either case.

In one example, the UE may transmit multiple preambles of a low level (e.g., level 0) to signify multiple transmission attributes to the BS. In this case, the UE must also transmit any preambles of a high level (e.g., level 1) associated to the transmitted multiple preambles of the low level.

In one example, the complexity can be further reduced by forming a preamble structure of K levels (K>1). A level n preamble K) is associated with at least one level (n−1) preamble. A level 0 preamble is associated with at least one transmission attributes. A UE transmitting any of the at least one level (n−1) preamble must also transmit the associated level n preamble. Preambles of different levels may or may not be based on the same family of sequences. The multi-level structure has to be acyclic (i.e., cycles cannot exist in the structure). Thus, the situation where a preamble ultimately is associated with itself can be avoided.

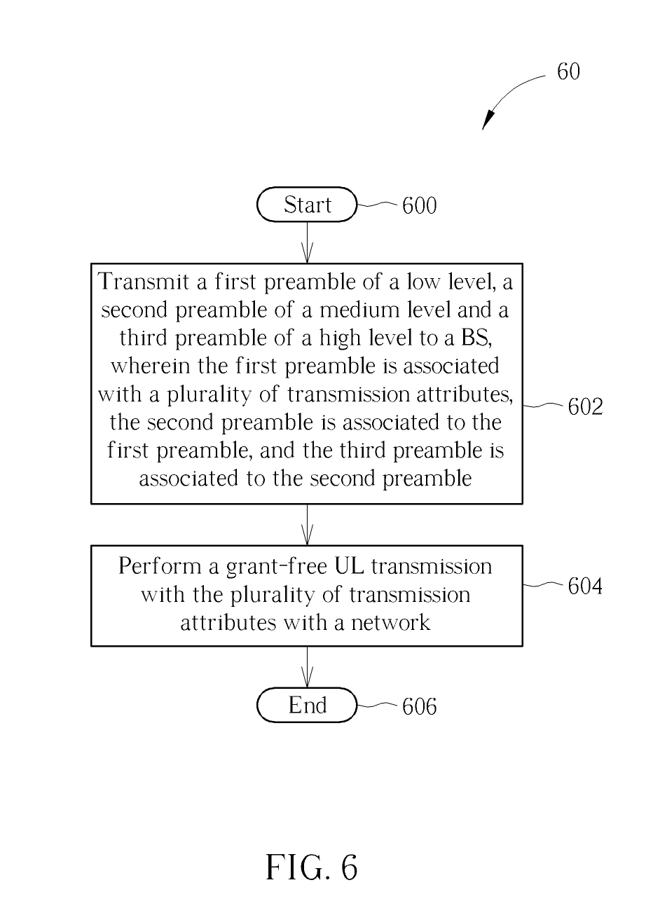

FIG. 6 is a flowchart of a process 60 according to an example of the present invention. The process 60 can be utilized in a UE, for reducing preamble detection complexity. The process 60 includes the following steps:

Step 600: Start.

Step 602: Transmit a first preamble of a low level, a second preamble of a medium level and a third preamble of a high level to a BS, wherein the first preamble is associated with a plurality of transmission attributes, the second preamble is associated to the first preamble, and the third preamble is associated to the second preamble.

Step 604: Perform a grant-free UL transmission with the plurality of transmission attributes with a network.

Step 606: End.

According to the Process 60, the UE transmits a first preamble of a low level (e.g., the level 0 preamble), a second preamble of a medium level (e.g., the level 1 preamble) and a third preamble of a high level (e.g., the level 2 preamble) to a BS, wherein the first preamble is associated with a plurality of transmission attributes, the second preamble is associated to the first preamble, and the third preamble is associated to the second preamble. Then, the UE performs a grant-free UL transmission with the plurality of transmission attributes with a network. That is, the UE transmits both the preamble of the low level associated to the transmission attributes and the preamble of the medium level associated to the preamble of the low level and the preamble of the high level associated to the preamble of the medium level.

The process 60 may correspond to the UE in the process 30. Examples of the process 30 may be applied to the process 60, and are not repeated herein.

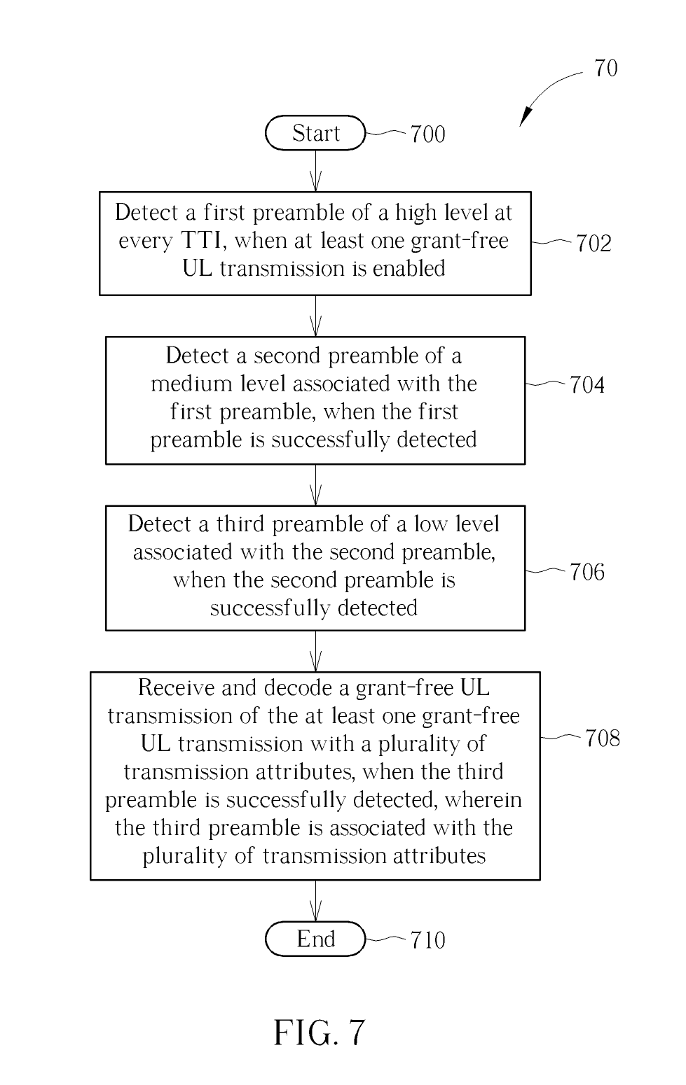

FIG. 7 is a flowchart of a process 70 according to an example of the present invention. The process 70 can be utilized in a BS, for reducing preamble detection complexity. The process 70 includes the following steps:

Step 700: Start.

Step 702: Detect a first preamble of a high level at every TTI, when at least one grant-free UL transmission is enabled.

Step 704: Detect a second preamble of a medium level associated with the first preamble, when the first preamble is successfully detected.

Step 706: Detect a third preamble of a low level associated with the second preamble, when the second preamble is successfully detected.

Step 708: Receive and decode a grant-free UL transmission of the at least one grant-free UL transmission with a plurality of transmission attributes, when the third preamble is successfully detected, wherein the third preamble is associated with the plurality of transmission attributes.

Step 710: End.

According to the process 70, when at least one grant-free UL transmission is enabled, the BS (attempts to) detects a first preamble of a high level (e.g., the level 2 preamble) at every transmission time interval (TTI) . When the first preamble is successfully detected, the BS detects a second preamble of a medium level (e.g., the level 1 preamble) associated with the first preamble. When the second preamble is successfully detected, the BS detects a third preamble of a low level (e.g., the level 0 preamble) associated with the second preamble. When the third preamble is successfully detected, the BS receives and decodes a grant-free UL transmission of the at least one grant-free UL transmission with a plurality of transmission attributes, wherein the third preamble is associated with the plurality of transmission attributes. That is, the BS detects the second preamble associated to the first preamble according to the successful detection of the first preamble. The BS does not detect the second preamble associated to the first preamble, if the first preamble is not successfully detected. The BS detects the third preamble associated to the second preamble according to the successful detection of the second preamble. The BS does not detect the third preamble associated to the second preamble, if the second preamble is not successfully detected. Thus, the complexity of the preamble detection can be reduced.

The process 70 may correspond to the BS in the process 40. Examples of the process 40 may be applied to the process 70, and are not repeated herein.

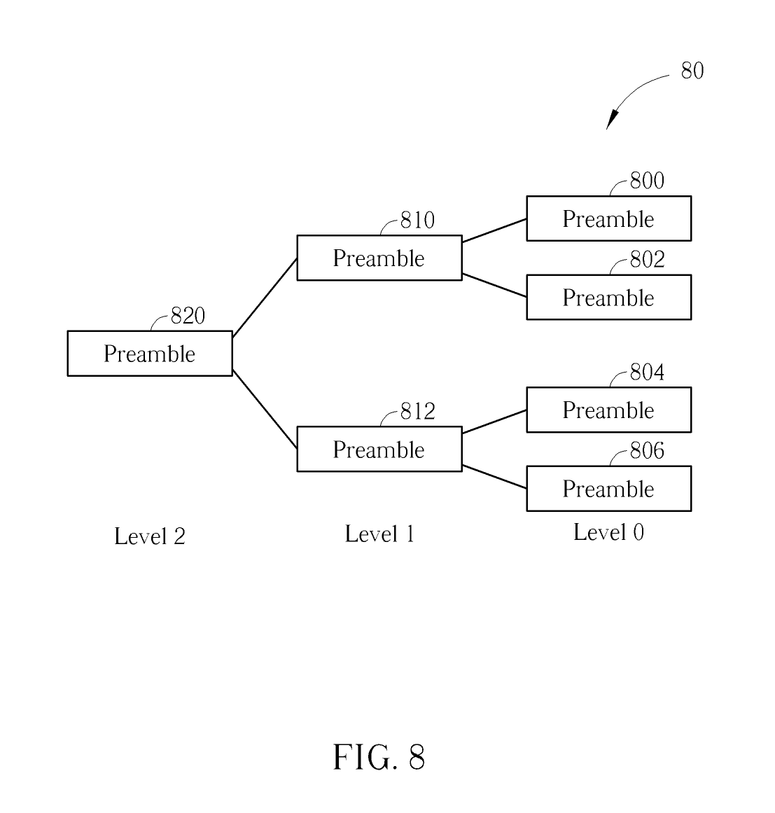

FIG. 8 is a schematic diagram of an association a plurality of preambles 80 according to an example of the present invention. The BS configures the preamble 820 as a high level (e.g., level 2). The BS configures the preambles 810 and 812 as a medium level (e.g., level 1). The BS configures the preambles 800, 802, 804 and 806 as a low level (e.g., level 0). The BS also configures the preambles 800 and 802 to be associated with the preamble 810 (i.e., a UE must transmit the preamble 810 if the UE transmits the preamble 800 or 802). Similarly, the BS configures the preambles 804 and 806 to be associated with the preamble 812. The BS configures the preambles 810 and 812 to be associated with the preamble 820 (i.e., a UE must transmit the preamble 820 if the UE transmits the preamble 810 or 812). The BS also configures the preambles 800, 802, 804 and 806 to signify the initial transmission, the first retransmission, the second retransmission and the third retransmission, respectively. The BS attempts to detect the preamble 820 at every TTI. The BS proceeds to detect the preamble 810 and 812 only according to the successful detection of the preamble 820. The BS continues to detect the preamble 800 and 802 only according to the successful detection of the preamble 810. The BS continues to detect the preamble 804 and 806 only according to the successful detection of the preamble 812. If the BS successfully detects the preamble 804, the BS understands that at least one UE performed the second retransmission. The BS receives and decodes a grant-free UL transmission using at least the knowledge of the second retransmission. A UE transmits the preamble 800, 802, 804 and 806 when performing the grant-free UL transmission, if the grant-free transmission is an initial transmission, a first retransmission, a second transmission and a third retransmission, respectively. Moreover, the UE must transmit the preamble 810 if the UE transmits the preamble 800 or 802. The UE must transmit the preamble 812 if the UE transmits the preamble 804 or 806. Finally, the UE must transmit the preamble 820 if the UE transmits the preamble 810 or 812.

By configuring the preambles with different levels, the BS avoids unnecessary detection operations of preambles if their associated preamble is not detected. The complexity of the detection of the BS can be reduced from O(N) to O(log(N)), where O( ) is the usual notation for representing asymptotic complexity and N is the number of the configured preambles.

In one example, the association between each preamble of a low level (e.g., level 0) and the transmission attributes can be fixed and written in a specification. Alternatively, such an association can be determined by the BS and higher-layer signaled to the UEs. Dynamic physical-layer signaling is not precluded. The association can also be implicitly determined based on a predetermined function or mechanism. In one example, a predefined hash function maps the numeric index associated with each preamble to an index of the MA signature. The function or mechanism itself can be written in a specification, higher-layer or dynamically signaled to the UEs.

The relationship among preambles with different levels can be fixed and written in a specification along with the preamble sequences themselves. Alternatively, it can be determined by the BS and higher-layer signaled to the UEs. Dynamic physical-layer signaling is not precluded. The association can be implicitly determined based on a predefined function or mechanism. For example, a predefined hash function maps the numeric index associated with each preamble to a level and to another preamble. The function or mechanism itself can be written in a specification, higher-layer or dynamically signaled to the UEs.

In one example, the multi-level preambles transmitted by a UE can have a concatenated structure such that a level (n−1) preamble appends to a level n preamble to which the level (n−1) preamble is associated.

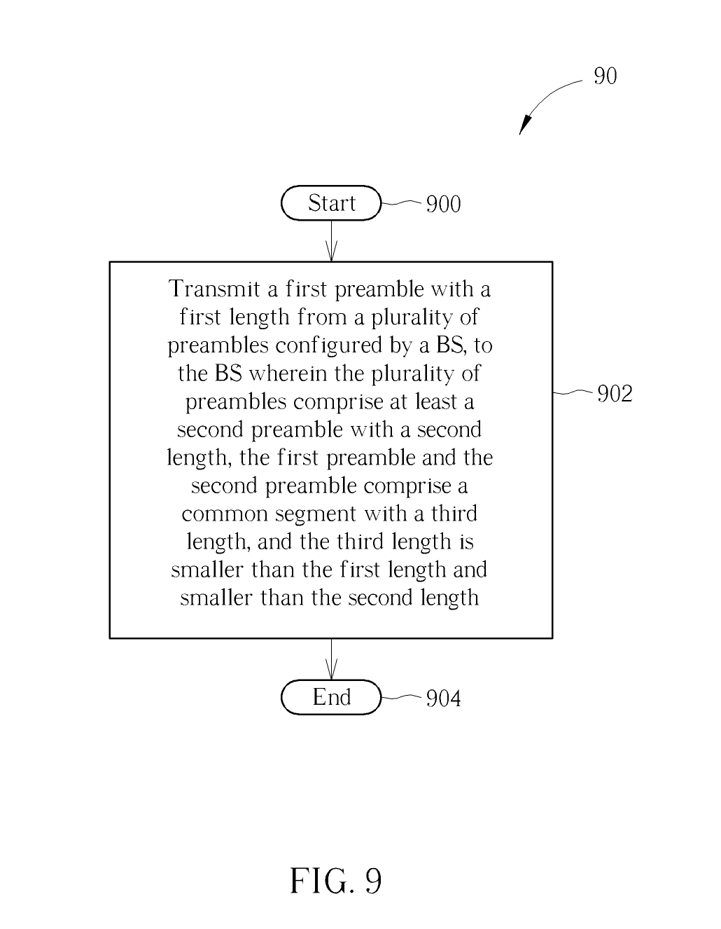

FIG. 9 is a flowchart of a process 90 according to an example of the present invention. The process 90 can be utilized in a UE, for reducing preamble detection complexity. The process 90 includes the following steps:

Step 900: Start.

Step 902: Transmit a first preamble with a first length from a plurality of preambles configured by a BS, to the BS; wherein the plurality of preambles comprise at least a second preamble with a second length, the first preamble and the second preamble comprise a common segment with a third length, and the third length is smaller than the first length and smaller than the second length.

Step 904: End.

According to the process 90, the UE transmits a first preamble with a first length from a plurality of preambles configured by a BS, to the BS; wherein the plurality of preambles comprise at least a second preamble with a second length, the first preamble and the second preamble comprise a common segment with a third length, and the third length is smaller than the first length and smaller than the second length.

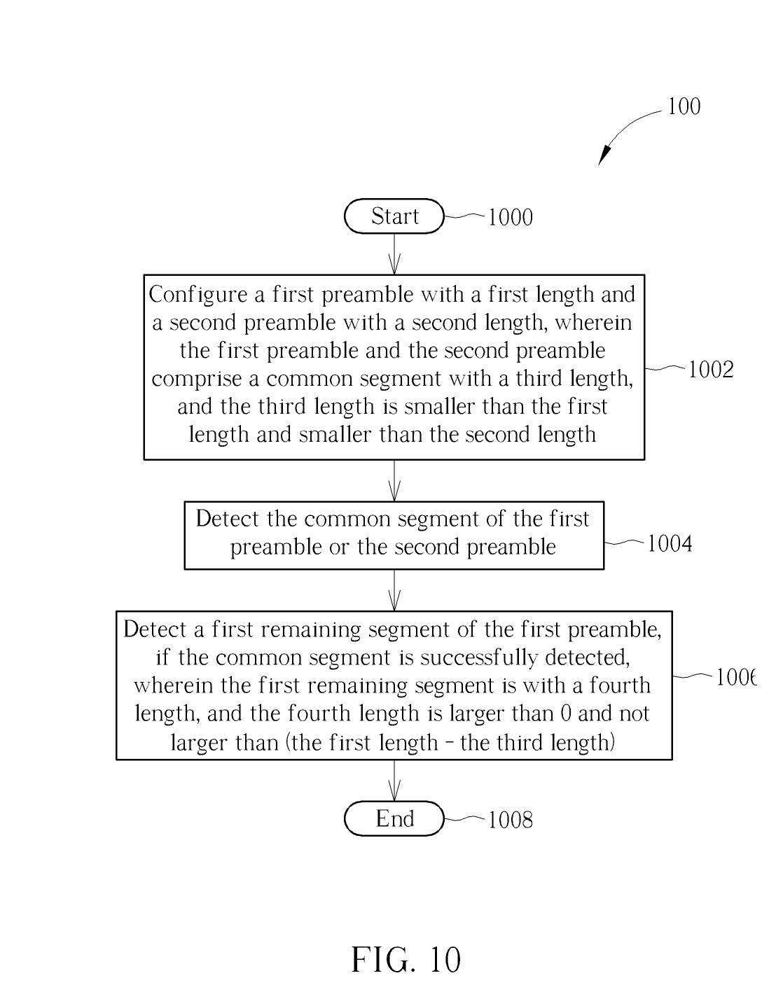

FIG. 10 is a flowchart of a process 100 according to an example of the present invention. The process 100 can be utilized in a BS, for reducing preamble detection complexity. The process 100 includes the following steps:

Step 1000: Start.

Step 1002: Configure a first preamble with a first length and a second preamble with a second length, wherein the first preamble and the second preamble comprise a common segment with a third length, and the third length is smaller than the first length and smaller than the second length.

Step 1004: Detect the common segment of the first preamble or the second preamble.

Step 1006: Detect a first remaining segment of the first preamble, if the common segment is successfully detected, wherein the first remaining segment is with a fourth length, and the fourth length is larger than 0 and not larger than (the first length—the third length).

Step 1008: End.

According to the process 100, the BS configures a first preamble with a first length and a second preamble with a second length, wherein the first preamble and the second preamble comprise a common segment with a third length, and the third length is smaller than the first length and smaller than the second length. Then, the BS detects the common segment of the first preamble or the second preamble. If the common segment is successfully detected, the BS detects a first remaining segment of the first preamble, wherein the first remaining segment is with a fourth length, and the fourth length is larger than 0 and not larger than (the first length—the third length). That is, the BS detects the common segment of the first preamble or the second preamble. If the common segment is successfully detected, the BS continues detecting the remaining segment of the first preamble or the second preamble. Thus, the complexity of the preamble detection can be reduced.

Realization of the process 100 is not limited to the above description. The following examples may be applied to the process 100.

In one example, if the common segment is successfully detected, the BS detects a second remaining segment of the second preamble, wherein the second remaining segment is with a fifth length, and the fifth length is larger than 0 and not larger than (the second length—the third length).

In one example, if the common segment is not successfully detected, the BS does not detect the first preamble.

In one example, when the first remaining segment is successfully detected, the BS receives and decodes a grant-free UL transmission of at least one grant-free UL transmission with a plurality of transmission attributes, wherein the first preamble are associated with the plurality of transmission attributes.

In one example, the complexity can be further reduced by forming a preamble structure of K levels (K>1). A level n preamble (1≤n≤K) K) is associated with at least one level (n−1) preamble. The level 0 preambles are associated with multiple transmission attributes, respectively. A UE transmitting any of the at least one level (n−1) preamble must also transmit the associated level n preamble. Preambles of different levels may or may not be based on the same family of sequences. The multi-level structure has to be acyclic (i.e., cycles cannot exist in the structure). Thus, the situation where a preamble ultimately is associated with itself can be avoided.

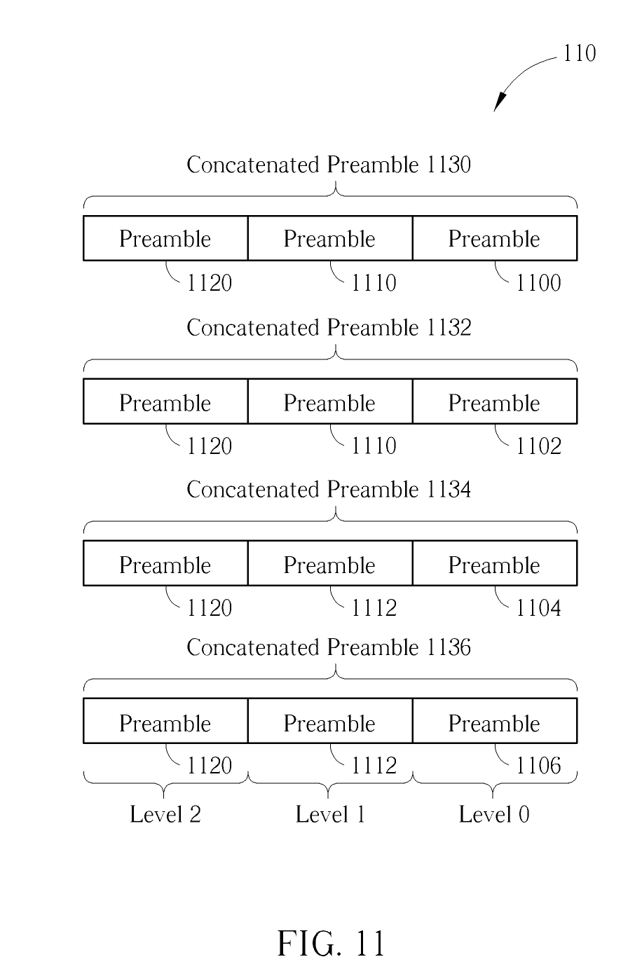

FIG. 11 is a schematic diagram of an association a plurality of preambles 110 according to an example of the present invention. The BS configures the preamble 1120 as a high level (e.g., level 2). The BS configures the preambles 1110 and 1112 as a medium level (e.g., level 1). The BS configures the preambles 1100, 1102, 1104 and 1106 as a low level (e.g., level 0). The BS also configures the preambles 1100 and 1102 to be associated with the preamble 1110. Similarly, the BS configures the preambles 1104 and 1106 to be associated with the preamble 1112. The BS configures the preambles 1110 and 1112 to be associated with the preamble 1120. The concatenated preamble 1130 is formed by appending the preambles 1120, 1110 and 1100, and is configured to signify the initial transmission. The concatenated preamble 1132 is formed by appending the preambles 1120, 1110 and 1102, and is configured to signify the first retransmission. The concatenated preamble 1134 is formed by appending the preambles 1120, 1112 and 1104, and is configured to signify the second retransmission. The concatenated preamble 1136 is formed by appending the preambles 1120, 1112 and 1106, and is configured to signify the third retransmission. The BS attempts to detect the segment for the concatenated preamble with the preamble 1120 at every TTI. The BS proceeds to detect the segment for the concatenated preamble with the preamble 1110 and 1112 only according to the successful detection of the preamble 1120. The BS continues to detect the segment for the concatenated preamble with the preamble 1100 and 1102 only according to the successful detection of the preamble 1110. The BS continues to detect the segment for the concatenated preamble with the preamble 1104 and 1106 only according to the successful detection of the preamble 1112. If the BS successfully detects the preamble 1104, the BS understands that at least one UE performed the second retransmission. The BS receives and decodes a grant-free UL transmission using at least the knowledge of the second retransmission. A UE transmits the concatenated preamble 1130, 1132, 1134 and 1136 when performing the grant-free UL transmission, if the grant-free transmission is an initial transmission, a first retransmission, a second transmission and a third retransmission, respectively.

Realization of the processes mentioned above is not limited to the above description. The following examples may be applied to the processes 30, 40, 60, 70, 90 and 100.

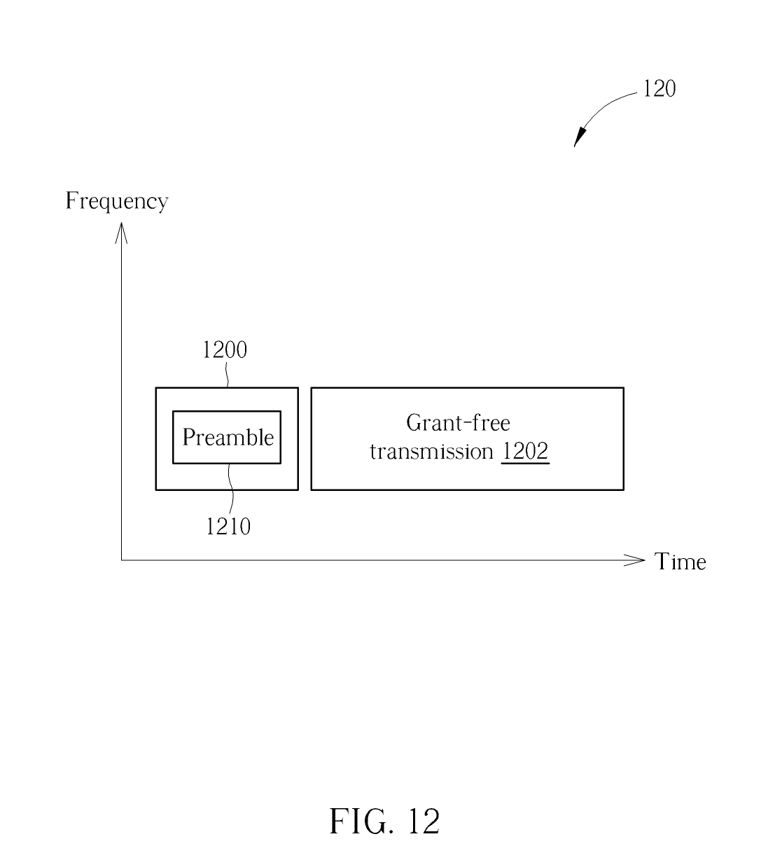

FIG. 12 is a schematic diagram of a time-frequency resource allocation 120 according to an example of the present invention. Each preamble of the preambles 1210 is transmitted by a UE. All the preambles 1210 are transmitted in a same time-frequency resource block 1200 accompanying a grant-free UL transmission 1202. In this case, each preamble of the preambles 1210 overlaps with one another in the time-frequency resource block 1200.

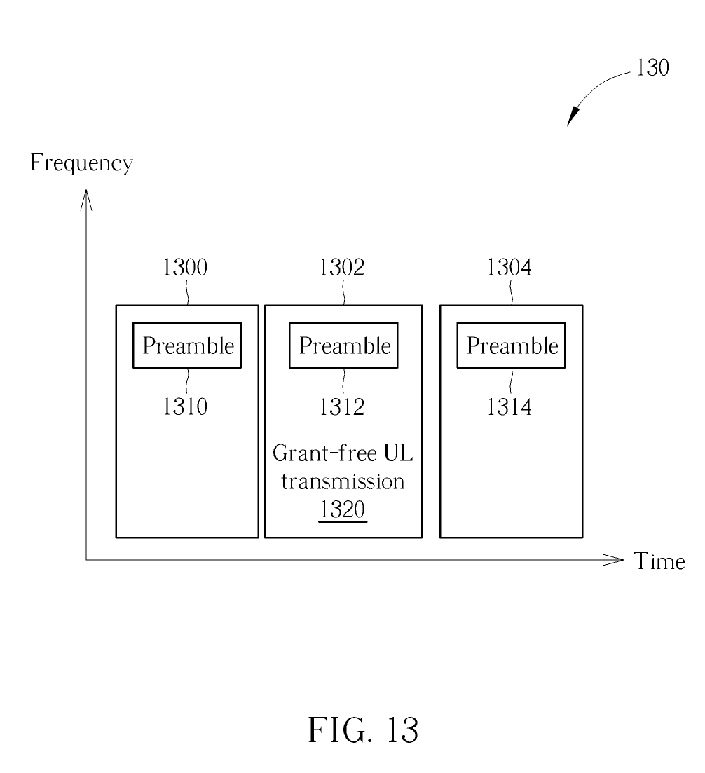

FIG. 13 is a schematic diagram of a time-frequency resource allocation 130 according to an example of the present invention. Each grant-free UL transmission 1320 is accompanied by the time-frequency resource blocks 1300 and 1304 where the preambles 1310 and 1314 are transmitted. The each grant-free UL transmission 1320 is preceded by a time-frequency resource block 1300 for transmitting the preamble 1310. The each grant-free UL transmission includes a time-frequency resource block 1302 for transmitting the preamble 1312. The each grant-free UL transmission is appended by a time-frequency resource block 1304 for transmitting the preamble 1314.

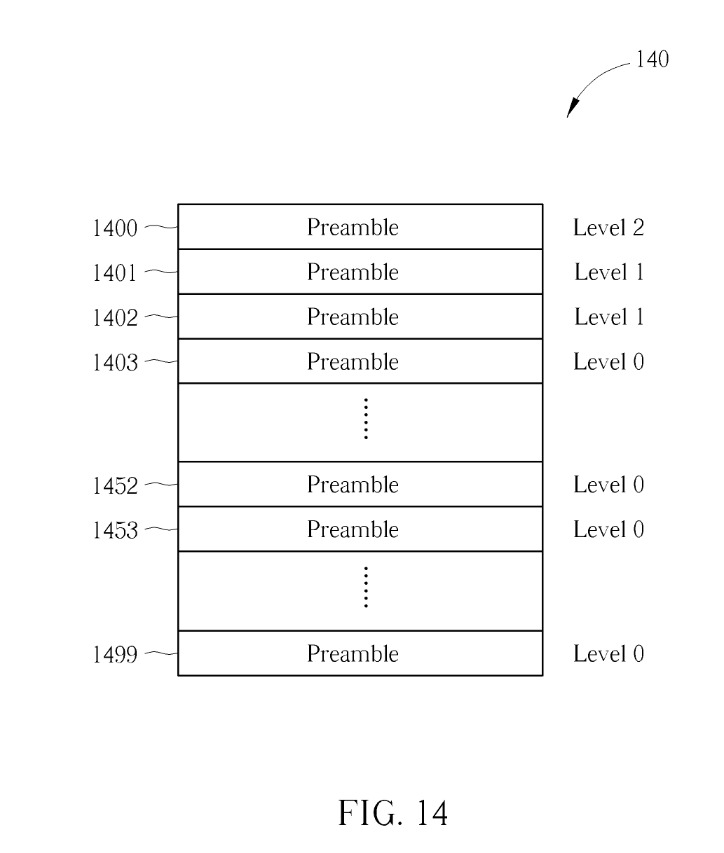

FIG. 14 is a schematic diagram of an association a plurality of preambles 140 according to an example of the present invention. The BS configures preambles 1400 to 1499 for the use of the grant-free UL transmission. The BS configures through higher-layer signaling to the UE that the preamble 1400 is level 2 and is associated with the preambles 1401 and 1402. The BS configures the preamble 1401 to be level 1 land to be associated with the preambles 1403 to 1452, which are all be configured to level 0. The BS configures the preamble 1402 to be level 1 and to be associated with the preambles 1453 to 1499, which are all be configured to level 0. The BS also configures through a one-to-one mapping between the preambles 1403 to 1499 and 97 different MA signatures through higher-layer signaling. A UE performs a grant-free UL transmission using a MA signature and transmits a level 0 preamble corresponding to the MA signature in a time-frequency resource as presented in FIG. 13. The UE also transmits a level 1 preamble to which the level 0 preamble is associated. The UE also transmits the preamble 1400 in the time-frequency resource. The BS detects the preamble 1400 and the level 1 preamble transmitted by the UE. The BS further detects the group of the level 0 preambles associated with the detected level 1 preamble and does not detect the other group of the level 0 preambles. Upon successful detection of the level 0 preamble, the BS understands the MA signature used by the UE. The BS then decodes the grant-free UL transmission with the knowledge of the MA signature. The channel state information inferred from the transmitted preamble can be utilized by the BS for recovering the UL data. It is also possible for the BS to configure the preambles 1403 to 1499 as UL demodulation reference signal (DMRS), and the UE transmits the grant-free UL transmission along with an UL DMRS with its sequence corresponding to the MA signature. The UE transmits the corresponding level 1 preamble and the preamble 1400 in the time-frequency resource as before. The UE also transmit those preambles in a time-frequency resource that has been set aside by the BS and is dedicated for the transmission of the preambles.

Those skilled in the art should readily make combinations, modifications and/or alterations on the abovementioned description and examples. For example, the skilled person easily makes new embodiments of the network based on the embodiments and examples of the UE, and makes new embodiments of the UE based on the embodiments and examples of the network. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. Any of the above processes and examples above may be compiled into the program code 214.

To sum up, the present invention provides a method and a communication device for reducing complexity of preamble detection. The BS determines a level for each preamble and avoiding the unnecessary detection of the preambles if their associated preamble is not detected. Thus, the problem of the art is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for reducing complexity of preamble detection, comprising:
a storage device; and
a processing circuit, coupled to the storage device, wherein the storage device stores, and the processing circuit is configured to execute instructions of:
being configured with a plurality of preambles;
transmitting a first preamble of the plurality of preambles; and
transmitting a second preamble of the plurality of preambles;
wherein the first preamble is associated with the second preamble according to an association.

2. The communication device of claim 1, wherein the first preamble is associated with a plurality of transmission attributes.

3. The communication device of claim 2, wherein the storage device further stores an instruction of:
performing a grant-free uplink (UL) transmission with the plurality of transmission attributes with a network.

4. The communication device of claim 2, wherein the plurality of transmission attributes comprise at least one of a user-equipment (UE) identity, a new data indication (NDI), a modulation coding scheme (MCS), a redundancy version (RV) index and a multiple access (MA) signature.

5. The communication device of claim 1, wherein the association is determined by a base station (BS).

6. The communication device of claim 1, wherein the first preamble and the second preamble are transmitted in a same time-frequency resource.

7. The communication device of claim 1, wherein the first preamble and the second preamble are transmitted in different time-frequency resources.

8. Abase station (BS) for reducing complexity of preamble detection, comprising:
a storage device; and
a processing circuit, coupled to the storage device, wherein the storage device stores, and the processing circuit is configured to execute instructions of:
configuring a plurality of preambles;
detecting a first preamble of the plurality of preambles;
detecting a second preamble of the plurality of preambles, if the first preamble is successfully detected; and
not detecting the second preamble, if the first preamble is not successfully detected;
wherein the second preamble is associated with the first preamble according to an association.

9. The BS of claim 8, wherein the association is determined by the BS.

10. The BS of claim 8, wherein the storage device further stores an instruction of:
receiving and decoding a grant-free UL transmission of at least one grant-free UL transmission with a plurality of transmission attributes, when the second preamble is successfully detected, wherein the second preamble is associated with the plurality of transmission attributes.

11. A communication device for reducing complexity of preamble detection, comprising:
a storage device; and
a processing circuit, coupled to the storage device, wherein the storage device stores, and the processing circuit is configured to execute instructions of:
transmitting a first preamble with a first length from a plurality of preambles configured by a base station (BS), to the BS;
wherein the plurality of preambles comprise at least a second preamble with a second length, the first preamble and the second preamble comprise a common segment with a third length, and the third length is smaller than the first length and smaller than the second length.

12. Abase station (BS) for reducing complexity of preamble detection, comprising:
a storage device; and
a processing circuit, coupled to the storage device, wherein the storage device stores, and the processing circuit is configured to execute instructions of:
configuring a first preamble with a first length and a second preamble with a second length, wherein the first preamble and the second preamble comprise a common segment with a third length, and the third length is smaller than the first length and smaller than the second length;
detecting the common segment of the first preamble or the second preamble; and
detecting a first remaining segment of the first preamble, if the common segment is successfully detected, wherein the first remaining segment is with a fourth length, and the fourth length is larger than 0 and not larger than (the first length—the third length).

13. The BS of claim 12, wherein the storage device further stores an instruction of:
detecting a second remaining segment of the second preamble, if the common segment is successfully detected, wherein the second remaining segment is with a fifth length, and the fifth length is larger than 0 and not larger than (the second length—the third length).

14. The BS of claim 12, wherein the storage device further stores an instruction of:
not detecting the first preamble, if the common segment is not successfully detected.

15. The BS of claim 12, wherein the storage device further stores an instruction of:
receiving and decoding a grant-free uplink (UL) transmission of at least one grant-free UL transmission with a plurality of transmission attributes, when the first remaining segment is successfully detected, wherein the first preamble is associated with the plurality of transmission attributes.
